(19) United States
(12) Patent Application Publication
(10) Pub. No.: US 2024/0258673 A1
(43) Pub. Date: Aug. 1, 2024

(54) DEVICE FOR MULTIPLEXING OR DEMULTIPLEXING POLARISED WAVES

(71) Applicant: HUAWEI TECHNOLOGIES CO., LTD., Shenzhen (CN)

(72) Inventors: Christian BLÜMM, Munich (DE); Changsong Xie, Munich (DE); Alexander Dyck, Weilheim (DE); Patrick Reynaert, Leuven (BE); Joren Vaes, Leuven (BE)

(73) Assignee: HUAWEI TECHNOLOGIES CO., LTD., Shenzhen (CN)

(21) Appl. No.: 18/392,765

(22) Filed: Dec. 21, 2023

Related U.S. Application Data
(63) Continuation of application No. PCT/EP2021/067781, filed on Jun. 29, 2021.

(51) Int. Cl. H01P 3/16

(52) U.S. Cl. CPC H01P 3/16

(57) ABSTRACT

A dielectric waveguide for spatially separating two orthogonally polarised components of an electromagnetic wave from each other, or for forming an electromagnetic wave having two orthogonally polarised components by spatially combining two linearly polarised electromagnetic waves. The dielectric waveguide comprises a first branch for carrying a first linearly polarised wave and a second branch for carrying a second linearly polarised wave. The dielectric waveguide comprises a dual-polarisation port which comprises a first area and a second area. The first area and the second area of the dual-polarisation port are a cross-section of the first branch and a cross-section of the second branch, respectively, and may partially overlap.

### CROSS-REFERENCE TO RELATED APPLICATIONS

This application is a continuation of International Application No. PCT/EP2021/067781 filed on Jun. 29, 2021, the disclosure of which is hereby incorporated by reference in its entirety.

### FIELD OF THE DISCLOSURE

This disclosure relates to multiplexing and demultiplexing polarised signals for transmission within dielectric waveguide cables.

### BACKGROUND

Communication over dielectric waveguide (DWG) cables, also known as polymer microwave fibres (PMF), is a candidate for filling a performance gap between copper and optical high-speed data links for medium range applications. A combination of millimeter-wave transceiver chips (30-300 GHz frequencies), small antennas, and a cheap plastic fiber offers robust, cost-effective, and low-weight high-speed communication links for various applications. Compared to copper, dielectric waveguide losses are lower and the bandwidth able to be achieved is higher. Compared to optical fiber, dielectric waveguides are a cheaper and more mechanically robust technology. See Maxime De Wit; Simon Ooms; Bart Philippe; Yang Zhang; Patrick Reynaert; “Polymer Microwave Fibers: A New Approach That Blends Wireline, Optical, and Wireless Communication”; IEEE Microwave Magazine; Vol. 21/1; 2020.

Like other communication technologies, polymer microwave fiber (PMF) communication can build upon multiple orthogonal transmission channels in order to increase data throughput or to allow for duplex communication. In a single PMF, orthogonal transmission channels can be realized by using both polarisations of an optical mode (e.g., a fundamental mode) of the PMF. Two signals with mutually orthogonal polarizations are also referred to as spatially orthogonal signals. To realize this polarisation diversity, so-called orthomode transducers (OMT) are needed. An OMT is a waveguide polariser device with three physical ports. In the context of the present technical field, the term “port” refers to a cross-section of a waveguide, or a cross-section of a branch of a waveguide. In this disclosure, a cross-section of an optical element (e.g., a cross-section of the waveguide or a cross-section of a branch of the waveguide) is understood to be a section (i.e., a cut) perpendicular to a main propagation direction of the wave (or signal) that propagates in the optical element, i.e., a cut perpendicular to an optical axis of the optical element. A port is not necessarily located at an end of the waveguide. The OMT's function is to simultaneously separate or combine two spatially orthogonal signals within the same frequency band. OMTs are also known as orthomode junctions, polarisation diplexers, or dual-mode transducers.

Existing OMTs for PMF communications are typically dual-polarisation coupler (antenna) designs. Such designs achieve polarisation selective coupling by way of the coupler geometry. They are used, for example, for patch antennas. See, e.g.:

Meyer A., Schneider M., “Robust design of a broadband dual-polarized transition from PCB to circular dielectric waveguide for mm-wave applications”; International Journal of Microwave and Wireless Technologies 12, 559-566, 2020;

U. Dey and J. Hesselbarth, “Millimeter-wave Chip-to-Chip Interconnect Using Plastic Wire Operating in Single and Dual Mode,” 2018 IEEE/MTT-S International Microwave Symposium—IMS, 2018;

Yu B., Ye Y., Ding X., Liu Y., Xu Z., Liu X. and Gu Q. J. “Ortho-mode sub-THz interconnect channel for planar chip-to-chip communications” IEEE Transactions on Microwave Theory and Techniques, 66, 1864-1873, 2018.

Such geometry-based couplers have four main drawbacks. First, dual-polarisation coupler designs typically have a complex, bulky shape. Integration into printed circuit boards or chip packages is difficult. Second, exciting individual polarisations is challenging. In order to support dual polarisations, coupler designs compromise the performance of the individual polarisations. Third, coupling efficiency relies on the manufacturing repeatability of the coupler structures to achieve good isolation. Fourth, the coupler structures need to be redesigned when the substrate, frequency band, or bandwidth is changed.

Existing PMF OMT coupler designs achieve orthogonal transmission channels in various ways. In one example, the PMF OMT realizes polarisation selectivity with a stacked patch coupler topology. If multi-mode DWGs are used, a transition between microstrip line and circular dielectric waveguide can be realized with a DWG port structure, which acts as a higher-order mode filter. This design has no polarisation-related functionality. The polarisation selectivity is realized by the geometry of the coupler design only. In another example, the PMF OMT realizes polarisation selectivity with a combination of a parasitic patch topology, a dielectric sphere, and a metallic aperture. Again, the polarisation selectivity is realized by the geometry of the coupler design alone. In yet a further example, the PMF OMT realizes polarisation selectivity using a differential probe topology. Once again, the polarisation selectivity is realized solely by the geometry of the coupler design.

In an alternative approach to the coupler design-based approaches described above, where the configuration of the interface between the electromagnetic component and the antenna (for example, in the form of a patch or probe) imparts the orthogonal transmission channels of the polarised wave, an OMT aperture has been created using metal waveguides. This design specifically concerns a polarisation selective coupling interface between two metal waveguides. The polarisation selective coupling interface is configured to enable horizontally polarised signals to pass between first and second linear propagation paths of the two waveguides but prevents vertically polarised signals from passing between the first and second linear propagation paths. The result is polarisation selectivity which is realized at the interface in the vertical plane between the two distinct metallic waveguides.

All of the above described OMT designs rely on designing the coupler itself for dual-polarisations. That is, the cross-shape of the multiplexed signals is formed by physically crossed antennas.

It is desirable to develop an OMT which can provide a dual-polarisation wave to a dielectric waveguide cable while avoiding additional coupling losses between the connector and PMF, being mechanically robust, with a high coupling efficiency, and flexible such that minimal alterations in its design are required for use over a range of substrates, frequency bands, and bandwidths.

### SUMMARY OF THE DISCLOSURE

According to one aspect, there is provided a dielectric waveguide for spatially separating two orthogonally polarised components of an electromagnetic wave from each other, or for forming an electromagnetic wave having two orthogonally polarised components by spatially combining two linearly polarised electromagnetic waves, the dielectric waveguide comprising a first branch for carrying a first linearly polarised wave and a second branch for carrying a second linearly polarised wave, the dielectric waveguide having a dual-polarisation port comprising a first area and a second area which overlap partially, the first area and the second area being a cross-section of the first branch and a cross-section of the second branch respectively. The word “port” refers to a cross-section of a waveguide or a cross-section of a branch of a waveguide. A port may notably be a cross-section at an end of the waveguide. A cross-section of a part of the waveguide is understood to be perpendicular to a main propagation direction of the electromagnetic wave in the respective part of the waveguide. In other words, a cross-section is a cut in a transverse plane (not a longitudinal plane) of the respective part. The waveguide provides a simple and effective way of multiplexing or demultiplexing electromagnetic waves.

The dual-polarisation port may have C4 symmetry. The dual-polarisation port may have D4 symmetry. Waveguide symmetry allows the electromagnetic wave to be highly symmetrical and can result in improved transmission properties of the waveguide. D4 symmetry has the additional advantage that the dual-polarisation port may have two orthogonal axes of reflection and the wave may therefore be symmetric (i.e., invariant) under geometrical reflections by any of these two axes.

The first branch and the second branch may each have an elongated (e.g., rectangular, oval, or elliptical) cross-section. An elongated cross-section can be beneficial for carrying a first polarisation component and rejecting a second polarisation component that is orthogonal to the first polarisation component.

The first branch and the second branch may separate (diverge) from each other gradually in space. This helps to minimise distortion and losses in the waves as they are demultiplexed.

At least one of the cross-section of the first branch and the cross-section of the second branch may rotate gradually in space. Thus, the polarisation vector of the wave in the first branch and/or the polarisation vector of the wave in the second branch gradually rotate in space as the wave propagates in the respective branch. In one embodiment, the polarisation vector of the first branch and the polarisation vector of the second branch rotate relative to each other as the two waves propagate in the two branches, minimising distortion and losses while enabling orthogonal polarisations in the dual-polarisation port and e.g., parallel polarisations in the two branches at positions distant from the dual-polarisation port.

The first branch and the second branch may be symmetric to each other under reflection by a plane that passes through the dual polarisation port. Thus, the two polarisation components can propagate symmetrically and characteristics such as loss, dispersion and polarisation can be kept similar in both branches.

A port of the first branch and a port of the second branch may be spatially separate. This facilitates full separation of the two orthogonally polarised components of the electromagnetic wave. It also facilitates connecting the waveguide to two spatially separate devices, using one device for each component.

A port of the first branch and a port of the second branch may be congruent and have a same orientation. The two ports may thus be particularly well adapted for receiving or delivering two waves that have a same polarisation. In this context “congruent” means identical in size and shape.

A longest axis of the port of the first branch and a longest axis of the port of the second branch may be orientated parallel to each other.

A longest axis of the port of the first branch and a longest axis of the port of the second branch may be orientated orthogonally to each other.

The port of the first branch and the port of the second branch may be partially overlapping and not parallel to each other.

Various relative configurations of the ports of the first and second branches are possible. Each configuration may have its own characteristics in loss and dispersion.

The dielectric waveguide may be made of a polymeric material.

According to another aspect, there is provided a method of guiding an electromagnetic wave comprising injecting the wave into the dielectric waveguide of claim 1. The two orthogonally polarised components may propagate in contrary directions at the dual-polarisation port. The two orthogonally polarised components may propagate in a same direction at the dual-polarisation port.

### BRIEF DESCRIPTION OF THE FIGURES

The present invention will now be described by way of example with reference to the accompanying drawings. In the drawings:

FIG. 1 shows an example configuration of the dielectric waveguide for multiplexing or demultiplexing polarised electromagnetic waves.

FIG. 2 shows a spatial sequence of cross-sections of the example waveguide depicted in FIG. 1.

FIG. 3 shows a plurality of example implementations of the waveguide in a communication system.

### DETAILED DESCRIPTION OF THE INVENTION

The proposed dielectric waveguide embodies a new type of orthomode transducer (OMT) or connector. In one application, the waveguide receives a signal that comprises two orthogonal polarisation components and separates the two components in space. In one embodiment, the waveguide rotates the two components until they become spatially separate signals having parallel polarisations. The waveguide can serve notably as a dual-polarisation interface between a circular PMF and two single-polarisation waveguides. In order to prevent additional coupling losses between connector and PMF, the connector may be made from a dielectric material similar to the PMF.

The dielectric waveguide or OMT multiplexes the polarisations with three physical ports such that one port contains the combined polarisations and the other two ports contain the individual plane polarisations. In the proposed device the multiplexing is achieved by a suitable choice of the physical dimensions, shape, and arrangement of the waveguide. The dielectric waveguide does not need to contain any internal crossed antenna or filters for selecting planar components of signals.

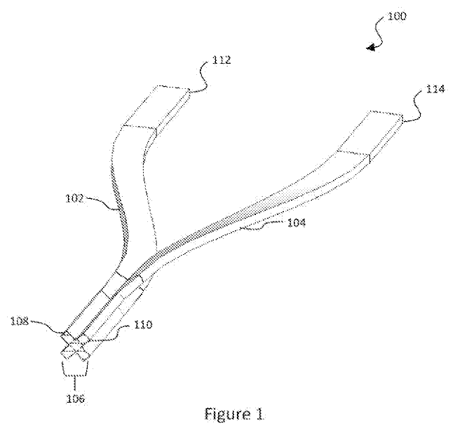

FIG. 1 shows an example configuration of the dielectric waveguide 100 for multiplexing or demultiplexing polarised electromagnetic waves. The dielectric waveguide may be configured to spatially separate two orthogonally polarised components of an electromagnetic wave from each other. Alternatively, the dielectric waveguide may be configured to form an electromagnetic wave having two orthogonally polarised components by spatially combining two linearly polarised electromagnetic waves. The dielectric waveguide comprises a first branch 102 for carrying a first linearly polarised wave and a second branch 104 for carrying a second linearly polarised wave. The dielectric waveguide comprises a dual-polarisation port 106 which comprises a first area 108 and a second area 110. The first area 108 and the second area 110 of the dual-polarisation port 106 are a cross-section of the first branch 102 and a cross-section of the second branch 104, respectively. The first area 108 and the second area 110 overlap partially.

In the shown example, the first area 108 and the second area 110 intersect each other orthogonally such that a longest axis of the first area and a longest axis of the second area are at right angles to each other. That is, the first and second areas 108 and 110 overlap to form a cross-shaped (e.g. “+”-shaped) cross-section. In operation, the respective components of the dual-polarised electromagnetic wave confined within the respective first and second areas of the waveguide. The physical dimensions of the waveguide confine the polarised waves in the orthogonal arrangement. The relative positions and orientations of the two separate linearly polarised waves present in the first branch 102 and second branch 104 can be altered in a sufficiently gradual manner such that they are combined as they follow the physical constraints of the waveguide, eventually combining to form a single dual-polarised wave.

In the present description, the word “port” refers to a cross section of a waveguide or a cross-section of a branch of a waveguide. A port is not necessarily located at an end of the waveguide. That is, the specific cross-section referred to by the term “port” may be located at any position along the waveguide.

The first branch 102 has a port 112 distant from the dual-polarisation port 108. Similarly, the second branch 104 has a port 114 distant from the dual-polarisation port 108. In the example, the ports 112 and 114 are each located at an end of the respective branch.

A dielectric waveguide is a waveguide consisting fully or primarily of a dielectric material. An electromagnetic wave (for example, a millimetre wave or microwave) can propagate in the dielectric medium where it is guided by the outer boundaries of the medium, that is, by the geometrical shape of the medium. The range of wavelengths for which the guiding effect is achieved corresponds roughly to the dimensions of the waveguide. In general, the higher the dielectric constant, the greater the guiding effect, but the higher the loss. The dielectric waveguide may be made of a polymeric material.

In one example of use, the waveguide enables antennas (not shown) at the ends of the first branch 102 and second branch 104 to be one-dimensional antennas. The two one-dimensional antennas may even be the same single antenna coupled separately to the two branches comprising the linearly polarised waves. In this way a single antenna may be used to input the same linearly polarised wave via both the first and second branches simultaneously, these waves may then be multiplexed together to provide a dual-polarised wave for transmission. The dual-polarised wave may then be demultiplexed at a far end to retrieve the two linearly polarised components which contain the same linear wave.

Alternatively, the input antenna for the first branch 102 and second branch 104 may be orientated orthogonally to each other such that the input linearly polarised waves are orthogonal to each other prior to entering the waveguide. As such, the two linearly polarised signals may not require relative rotation within the waveguide in order to combine the two waves to form a single dual-polarised wave with orthogonal components. That is, the two linearly polarised waves may already be spatially orientated with respect to each other such that they are orthogonal but still in separate branches, which would then only need to be brought together such that they intersect each other with no relative rotation being required. Thus, the dielectric waveguide may be configured such that a port of the first branch and a port of the second branch are orientated orthogonally to each other (not shown).

The dielectric waveguide may be configured such that the first branch and the second branch are symmetric to each other under reflection in a plane that passes through the dual polarisation port. For example, the plane may pass through the centre of the dual-polarisation port between the branches, or midway through both branches, such that the physical shape of the branches is symmetrical in this plane. Thus, the two polarisation components can propagate symmetrically and characteristics such as loss, dispersion, and polarisation can be kept the same or as similar as possible in both branches. Similarly, the dielectric waveguide may be configured such that a port of the first branch and a port of the second branch are orientated parallel to each other.

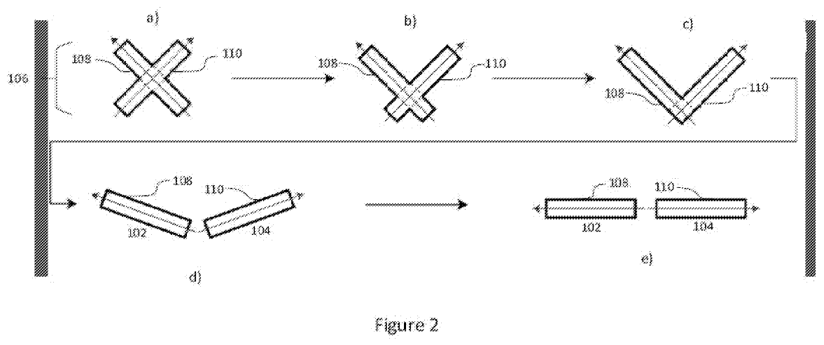

FIG. 2 shows a sequence of ports or cross-sections of the waveguide depicted in FIG. 1. The sequence starts at a) with a port for receiving or emitting a dual-polarised wave and ends at e) with two separate ports for receiving or emitting two separate linearly polarised waves. The ports or cross-sections are shown such that the direction of propagation of the polarised wave is perpendicular to the plane of the page. That is, all polarised waves are being transmitted in a direction into or out of the page.

In FIG. 2 part a), the port 106 is the cross-section of the waveguide at a location within the waveguide where a dual-polarised wave is transmitted. The dual-polarisation port 106 may have C4 symmetry. This means that the dual polarisation port is invariant under rotations of 90 degrees about its centre. That is, if rotated about a longitudinal axis of the waveguide at the dual-polarisation port by integer values of 90 degrees, where the longitudinal axis is an axis parallel to a propagation direction of the electromagnetic wave at the dual-polarisation port, the port looks the same. However, a port with C4 symmetry does not necessarily have reflective symmetry along any axis in the plane of the port. In other words, the first area 108 and the second area 110 (i.e. the cross-section of the first branch 102 and the cross-section of the second branch 104 at the dual polarisation port 106) may be congruent and arranged relative to each other with an angle of 90 degrees, where “congruent” means identical in size and shape. The dual-polarisation port 106 having C4 symmetry allows the electromagnetic wave to be highly symmetrical and can result in good transmission properties of the waveguide.

The dual-polarisation port 106 may have D4 symmetry. D4 symmetry is the same order of symmetry as a square. The dual-polarisation port may, for example, be cross-shaped or have the shape of four-leaf clover. D4 symmetry has the above mentioned advantages of C4 symmetry. In addition, the dual-polarisation port has two orthogonal axes of reflection and is symmetric under reflections in any of these two axes.

Parts b) to d) of FIG. 2 show the port of the waveguide as the first branch 102, comprising the first area 108, and the second branch 104, comprising the second area 110, separate (diverge) from each other gradually in space. By separating the two waves confined within the first area 108 and second area 110 respectively in a gradual manner, distortions and losses can be minimised. The degree of gradual separation depends on the frequency and wavelength of the wave, the reflective index of the dielectric the waveguide is made of, and the sharpness of the bend in the boundaries of the waveguide.

In parts c) to e) of FIG. 2 the cross-section of the first branch 102 and the cross-section of the second branch 104 can also be seen to rotate relative to each other gradually in space. Thus, the polarisation vector of the wave in the first branch 102 and the polarisation vector of the wave in the second branch 104 gradually rotate relative to each other as the two waves propagate in the two branches. In one embodiment, the two vectors rotate from a relative angle of 90 degrees at the dual polarisation port to a relative angle of zero or 180 degrees between a port 108 of the first branch and a port 110 of the second branch.

In FIG. 2 part e) the first port 108 of the first branch 102 and the second port 110 of the second branch 104 can be seen to be spatially separate from each other. Such a physical separation facilitates full separation of the two orthogonally polarised components of the electromagnetic wave. It also facilitates connecting the waveguide to two spatially separate devices, using one device for each component. For example, the two spatially separate devices may be two separate and distinct antennas. The two spatially separate devices may be two waveguides (especially two single-polarisation waveguides), or two transceivers, or one receiver and one transmitter. In this context the term “spatially separate” means not intersecting and not overlapping.

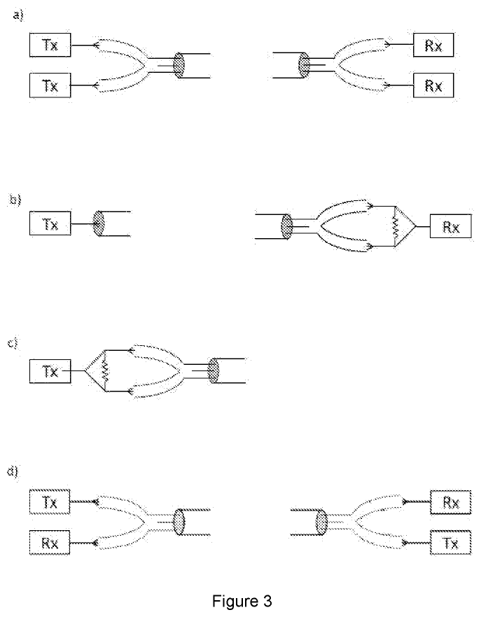

FIG. 3 shows a plurality of example implementations of the waveguide in a communication system. As mentioned above, the waveguide may be used to multiplex waves or de-multiplex waves. Therefore, it should be appreciated that the waveguide can be implemented at one or more ends of a communication path in a plurality of ways depending on the signal requirements and purposes thereof. The waveguide can be used for the following different Tx/Rx configurations.

FIG. 3 part a) shows the waveguide implemented in a dual-polarisation transmission system. The waveguide is used both in the transmission, TX, side as a polarisation combiner and in the reception, RX, side as a polarisation splitter.

FIG. 3 part b) shows the waveguide implemented in a single-polarisation transmission system. The waveguide is used in the receiver side as an orthogonally polarised signal splitter, e.g. in a setup in which the polarization of the received signal is unknown.

FIG. 3 part c) shows the waveguide implemented in the transmitter side of the system. In the shown example, a signal from a transmitter Tx is split by a splitter into two spatially separate signals. The two spatially signals are injected into two spatially separate ports of the two branches of the waveguide. The two signals propagate in the two branches toward the dual-polarisation port. At the dual-polarisation port their polarizations will be orthogonal to each other

FIG. 3 part d) shows the waveguide implemented in the typical duplex use case. In this example the two orthogonal components of the dual-polarised wave are used for the transmitted and received components of the communication.

Thus, according to the requirements of various implementations, the dielectric waveguide may be configured such that a port of the first branch and a port of the second branch are congruent and have a same orientation. The two ports can thus be particularly well adapted for receiving or delivering two waves that have a same polarisation (i.e. have parallel polarisation vectors). For example, the two ports may each have an elongated shape such as an oval or rectangular shape. In this context “congruent” means identical in size and shape.

The waveguide as proposed herein is configured to be used in a method of guiding an electromagnetic wave. The method of guiding an electromagnetic wave comprises injecting the wave into the dielectric waveguide configured as described herein. The injected electromagnetic wave may be a dual-polarised wave having two orthogonally polarised components. The two orthogonally polarised components may be a transmitted wave and a received wave, respectively. The two orthogonally polarised components may be two transmitted waves, or the two orthogonally polarised components may be two received waves. The two orthogonally polarised components may be received at the dual-polarisation port via the first branch and the second branch, respectively.

The injected electromagnetic wave may be a first linearly polarised wave or a second linearly polarised wave. The first linearly polarised wave and the second linearly polarised wave may be a transmitted wave and a received wave, respectively. The first linearly polarised wave and the second linearly polarised wave may be two transmitted waves, or the two orthogonally polarised components may be two received waves.

The waveguide described herein above provides the advantages that any coupler design can be supported by the waveguide as a multiplexer. There is no compromise on individual polarisations necessary. Further, the proposed simpler and more flexible geometries than existing methods allow for easier integration into printed circuit boards or chip packages. Whatever shape is needed for conforming to the space available on the circuit board can be realized. There is again no compromise on the coupling to achieve the necessary shape. Additionally, the dual-polarisation coupling efficiency relies essentially on the geometry of the waveguide as multiplexer. This is a consequence of the nature of the coupling mechanism between the linearly polarised waves. Also, no redesign of the waveguide is necessary to accommodate different substrates, frequency bands, or bandwidths. The fundamental mechanisms of the waveguide acting as a multiplexer or demultiplexer remain unchanged when these parameters are changed.

The above described waveguide may be implemented in a system comprising dielectric waveguide cables, also known as polymer microwave fibers, with various cross-sections. For example, the cable or fibre cross-sections may be cross-shaped, in keeping with the dual-polarised port of the waveguide. Alternatively or additionally, the cable may have an oval cross-section. Other cross-section shapes may be employed, such as square, rectangular, or circular. One axis of the cable cross-section may be dimensioned relative to another orthogonal axis of the cable cross-section to minimize or stop relative rotation of a dual-polarised signal inside the waveguide cable.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A dielectric waveguide, comprising:
a first branch for carrying a first linearly polarised wave; and
a second branch for carrying a second linearly polarised wave, the dielectric waveguide having a dual-polarisation port comprising a first area and a second area which overlap partially, the first area and the second area being a cross-section of the first branch and a cross-section of the second branch respectively.

2. The dielectric waveguide according to claim 1, wherein the dual-polarisation port has C4 symmetry.

3. The dielectric waveguide according to claim 1, wherein the dual-polarisation port has D4 symmetry.

4. The dielectric waveguide according to claim 1, wherein the first branch and the second branch diverge gradually from each other in space.

5. The dielectric waveguide according to claim 1, wherein the first branch and the second branch each have an elongated cross-section.

6. The dielectric waveguide according to claim 1, wherein at least one of the cross-section of the first branch and the cross-section of the second branch rotates gradually in space.

7. The dielectric waveguide according to claim 1, wherein the first branch and the second branch are symmetric to each other under reflection by a plane that passes through the dual polarisation port.

8. The dielectric waveguide according to claim 1, wherein a port of the first branch and a port of the second branch are spatially separate.

9. The dielectric waveguide according to claim 8, wherein the port of the first branch and the port of the second branch are congruent and have a same orientation.

10. The dielectric waveguide according to claim 8, wherein a longest axis of the port of the first branch and a longest axis of the port of the second branch are orientated parallel to each other.

11. The dielectric waveguide according to claim 8, wherein a longest axis of the port of the first branch and a longest axis of the port of the second branch are orientated orthogonal to each other.

12. The dielectric waveguide according to claim 1, wherein a port of the first branch and a port of the second branch are partially overlapping and not parallel to each other.

13. The dielectric waveguide according to claim 1, wherein the dielectric waveguide is made of a polymeric material.

14. A method of guiding an electromagnetic wave, comprising:
injecting a wave into a dielectric waveguide, the dielectric waveguide comprising:
a first branch for carrying a first linearly polarised wave; and
a second branch for carrying a second linearly polarised wave, the dielectric waveguide having a dual-polarisation port comprising a first area and a second area which overlap partially, the first area and the second area being a cross-section of the first branch and a cross-section of the second branch, respectively.

15. The method according to claim 14, wherein the two orthogonally polarised components propagate in contrary directions at the dual-polarisation port.

16. The method according to claim 15, wherein the two orthogonally polarised components propagate in a same direction at the dual-polarisation port.
